(19) United States
(12) Patent Application Publication
(10) Pub. No.: US 2005/0075245 A1
(43) Pub. Date: Apr. 7, 2005

(54) Carbon-based compositions for reversible hydrogen storage

(76) Inventors: William A. Goddard III, Pasadena, CA (US); WeiQiao Deng, Pasadena, CA (US); Xin Xu, Xiamen (CN)

Correspondence Address: REED INTELLECTUAL PROPERTY LAW GROUP, 800 MENLO AVENUE, SUITE 210, MENLO PARK, CA, 94025, US

(21) Appl. No.: 10/719,000

(22) Filed: Nov. 21, 2003

Related U.S. Application Data
(60) Provisional application No. 60/428,169, filed on Nov. 21, 2002.

(51) Int. Cl. B01J 20/20

(52) U.S. Cl. 502/417; 252/378 R

(57) ABSTRACT

Carbon-based hydrogen storage compositions comprising a pillared carbon material doped with a metal, including compositions containing a pillared carbon material combined with alkali metals and/or alkaline earth metals for use in reversible hydrogen storage applications, are described. Methods of making such compositions and applications of such compositions are also described.

### CROSS-REFERENCE TO RELATED APPLICATIONS

This application claims priority under 35 U.S.C. § 119(e)(1) to Provisional U.S. Patent Application Ser. No. 60/428,169, filed Nov. 21, 2002, the disclosure of which is incorporated by reference herein in its entirety.

### TECHNICAL FIELD

This invention relates generally to the field of carbon materials doped with metals. More specifically, the invention relates to compositions containing pillared carbon materials combined with alkali metals and/or alkaline earth metals for use in reversible hydrogen storage applications, and to methods of making carbon-based compositions containing such materials.

### BACKGROUND OF THE INVENTION

Perhaps the most promising technology to dramatically decrease pollution while conserving the decreasing supply of fossil fuel is the use of hydrogen fuel cells in transportation. Unfortunately this solution is impeded by the lack of safe and economical ways to store the hydrogen onboard a vehicle. The U.S. Department of Energy (DOE) has estimated that attaining a suitable driving range for automotive applications will require storing 6.5 mass % of hydrogen, (density of 62.5 kg/m³). At the present time, some of the best materials, such as cubic TiV₂, however, can only store up to 2.6 mass % hydrogen at 10 bar and 313 K.¹

Recent claims of large hydrogen uptake for lightweight nanostructured carbon materials, in the form of tubes²⁻⁵, fibers⁶⁻⁷ and mechanically milled graphite⁸ have attracted considerable experimental and theoretical interest. For example, Ye et al. used high-purity single-walled carbon nanotubes (SWNTs) and reportedly obtained ˜8.0 mass % of H₂ adsorption at 80 K and above 100 bar³. Browning et al. reported 6.5 mass % hydrogen can be stored in carbon nanofibers under conditions of 120 bar pressure and ambient temperature⁷. These H₂ uptake systems require either high pressure⁷, or very low temperatures⁶, or both³, which limit their applicability for mobile applications requiring working conditions of roughly 1-20 bar and ambient temperatures.

Chen et al. reported remarkable hydrogen-storage capacities of 20 mass % for Li-doped nanotubes at 653 K and 14 mass % for K-doped nanotubes at room temperature⁹. Also reported were smaller but still significant absorptions in alkali-doped graphite (14 mass % for Li and 5 mass % for K)⁹. Later studies, however, revealed that these high H₂ uptakes were due to the impurity water gain/loss present in the hydrogen feedstream rather than to H₂ itself^{10,11}.

A variety of carbon materials intended to be suitable for hydrogen storage applications have also been disclosed in the patent literature. For example, in U.S. Pat. No. 5,653,951 to Rodriguez et al., the storage of hydrogen in layered nanostructures is described, while in U.S. Pat. No. 6,294,142 to Nazri et al., a hydrogen storage composition said to be a fully-reacted alkali metal intercalated graphitic carbon composite is provided. As well, in U.S. Pat. No. 6,471,936 to Chen et al., a metal-doped carbon-based material said to generally be an alkali metal-doped carbon-based material prepared by mixing a carbon material with an alkali metal salt and calcining the mixture under an atmosphere of inert or reductive gas is described.

In U.S. Pat. No. 6,517,800 to Cheng et al., a method for producing a single-walled carbon nanotube (SWNT) product by a hydrogen arc discharge method is described in which a hydrogen storage material may also be produced by soaking the SWNT product in an acid or oxidative reactant and heating under vacuum.

A hydrogen storage process utilizing carbon-metal hybrid materials is further described in U.S. Pat. No. 6,596,055 to Cooper et al., in which the metal portion of the carbon-metal hybrid may be a platinum group metal or another Transition Series metal.

Although carbon materials for hydrogen storage have been suggested in the literature and in the aforementioned patents, a continuing need exists for new carbon materials and carbon-based compositions that can provide desirable characteristics for hydrogen storage applications.

### SUMMARY OF THE INVENTION

The present invention addresses the aforementioned needs in the art, and provides improved carbon materials that are particularly suitable for hydrogen storage applications.

In one aspect of the invention, a carbon-based hydrogen storage composition is provided, in which the composition comprises a pillared carbon material doped with a metal.

In another aspect of the invention, a hydrogen storage system comprising a carbon-based composition is provided, in which the composition comprises a pillared carbon material doped with a metal.

In a further aspect of the invention, a method of making a carbon-based hydrogen storage composition is provided, wherein the method comprises
providing a solvated alkali metal containing organic ligands;
combining a carbon material with the solvated alkali metal containing organic ligands to form a carbon material co-intercalated with solvated alkali metal containing organic ligands;
carrying out a reaction between the organic ligands and the carbon material to form a pillared carbon material; and
doping the pillared carbon material with a metal.

Additional aspects, advantages and features of the invention will be set forth in part in the detailed description that follows, and will become apparent to those skilled in the art upon examination of the following, or may be learned by practice of the invention through routine experimentation.

### BRIEF DESCRIPTION OF THE FIGURES

FIG. 1 depicts an illustrative scheme to synthesize Li-doped pillared graphene or nanotubes of high Li-doping concentrations and large interlayer distances.

FIG. 2A-2B, collectively referred to as FIG. 2, depict the dependence of the mass hydrogen storage capacity on the interlayer (or intertube) distances under various pressures for doped and undoped pillared graphite and nanotubes. In FIG. 2A, graphite (open symbols, curves d, e and f) and Li-GIC or Li-PGS (filled symbols, curves a, b and c) are shown; and in FIG. 2B, (10,10) SWNTs (open symbols, curves d, e and f) and Li-P-SWNT (filled symbols, curves a, b and c) systems are shown. The doping concentration is Li:C=1:6. The pressures are: square=50 bar; circle=10 bar and triangle=1 bar.

FIG. 3A-3B, collectively referred to as FIG. 3, depict, in FIG. 3A, the effects of Li-doping concentration on the mass hydrogen storage capacity in Li-PGS under various pressures, and in FIG. 3B, the binding energy per Li atom for Li-PGS under various Li-doping concentrations. In FIGS. 3A and 3B, the square, corresponds to the equilibrium interlayer distance (curve a in FIG. 3B), the circle corresponds to an interlayer distance of 8 Å (curve b in FIG. 3B), and the triangle corresponds to an interlayer distance of 10 Å (curve c in FIG. 3B). The zero energy reference corresponds to pure graphite crystal and pure Li metal.

FIG. 4A-4B, collectively referred to as FIG. 4, depict the optimization of nanostructures. In FIG. 4A, Li-DPG and, in FIG. 4B, Li-doped SWNTs for mass (open symbols) and volumetric (filled symbols) hydrogen storage capacities are shown. The Li-doping concentrations are Li:C=1:3. The DOE target of 6.5 mass % is shown by a horizontal line. The optimum interlayer or intertube distance is indicated by an arrow. Key: square=50 bar; circle=20 bar and triangle=10 bar.

FIG. 5A-5B, collectively referred to as FIG. 5, depict the temperature and pressure effects on the mass hydrogen storage capacity for the Li-DPG and Li-doped pillared SWNTs. In FIG. 5A, Li-DPG:Li:C=1:3 and interlayer distance=10 Å is shown; in FIG. 5B, Li-doped pillared SWNTs:Li:C=1:3 and intertube distance=9 Å is shown. The hydrogen uptake at pressures of 0.01, 0.1, 1, 10, 20 and 50 bar are shown.

### DETAILED DESCRIPTION OF THE INVENTION

### Definitions and Nomenclature

The definitions set forth herein apply only to the terms as they are used in this patent and may not be applicable to the same terms as used elsewhere, for example in scientific literature or other patents or applications, including other applications by these inventors or assigned to common owners. The following description of embodiments and examples are provided by way of explanation and illustration. As such, they are not to be viewed as limiting the scope of the invention as defined by the claims. Additionally, when examples or illustrations are provided, they are intended to be exemplary only and not to be restrictive. As well, when it is said that a particular feature may be “included,” it is intended to imply that such features may be present but not that they are necessarily required.

As used in this specification and in the appended claims, the singular forms “a”, “an” and “the” include plural referents unless the context clearly dictates otherwise. Thus, for example, reference to “a metal” or “an organic solvent” includes a mixture of two or more metals or a mixture of two or more such solvents, and the like. Similarly, the phrase “combinations thereof” includes mixtures of one or more of the same category of referent, as well as mixtures of different referents. More particularly, the combination of alkali metals and alkaline-earth metals is intended to include mixtures of one or more alkali metals with one or more alkaline-earth metals, in addition to a mixture of one alkali metal and one alkaline-earth metal.

Unless otherwise indicated, this invention is not limited to specific compositions, components, or process steps. The terminology used herein is for the purpose of describing particular embodiments only and is not intended to be limiting.

In this specification and in the claims that follow, reference will be made to a number of terms, which shall be defined to have the following meanings:

As used herein, any reference to a “structure” is intended to be descriptive rather than limiting and is used in the same way that the term “comprising” is commonly used. For example wherein a material is said to have a “structure,” it is not intended that the material be limited to only such a structure, but rather that the material comprises such a structure.

The term “carbon material” is generally meant to refer to materials which are essentially carbon, although impurities and/or additives may be present, generally in minor amounts. For example, at least some of the carbon atoms in a “carbon material” may be replaced by boron or nitrogen atoms, either as an impurity or as an additive, i.e., as a purposely added element that may replace some of the carbon atoms in the material.

The term “doped” or “doping” is intended to generally refer to the addition of a material, e.g. a metal, to a carbon material. Such additions may, but do not necessarily include, replacement of carbon atoms within the carbon material with the metal.

The term “co-intercalated” is generally intended to refer to the intercalation of more than one material into a carbon material. Although this term is not limited thereto, in the case of a solvated alkali metal, for example, both the metal and the solvent may be intercalated into the carbon material. Also included within the intended meaning of this term is the intercalation of mixtures of metals into a carbon material.

As used herein, the term “pillared,” as in “pillared carbon material,” refers to an alteration in a carbon material in which parts of the carbon material are separated from each other (e.g., separating graphene sheets or separating nanotubes) by the pillar, providing space for metal and hydrogen that is combined with the carbon material (e.g., by increasing the interlayer or intertube distance). Although no particular form of structure is necessarily intended by the use of this terminology, the “pillared” carbon material alteration is intended to be stable and allow for further processing, such as mechanical milling of the carbon material, without significant disruption of the pillared structure. The “pillared” carbon material thus differs from metal-doped or intercalated carbon materials in that the alteration (e.g. increased interlayer or intertube distance) is comparatively stable. For example, carbon materials having an increased interlayer or intertube distance which are not “pillared” eventually will revert back to an equilibrium interlayer or intertube distance of about 3.4 Å, whereas “pillared” carbon materials maintain the increased interlayer or intertube distance. “Pillared” carbon materials also are distinguished over carbon materials and nanostructures referred to in the aforementioned patents (e.g. U.S. Pat. No. 6,471,936 to Chen et al.) since the structures mentioned therein are not pillared.

Unless otherwise indicated, the term “solvated alkali metal containing organic ligands” refers to an alkali metal solvated in an organic solvent in which at least some of the organic solvent is associated with alkali metal cations, e.g., by forming a metal-solvent complex.

The term “hydrogen storage system” is intended to refer to any device or apparatus, or methods of using such a device or apparatus, for the storage of hydrogen, including reversible hydrogen storage, and the use of such stored hydrogen.

The term “heterocyclic” generally refers to a cyclic compound that is heteroatom-containing, including, e.g., oxygen-containing heteroatom compounds such as furan compounds, and the like. Included within this term are “substituted” heterocyclic compounds containing a non-hydrogen substituent in which at least one hydrogen atom bound to a carbon (or other) atom of a heterocyclic compound is replaced with a non-hydrogen substituent.

### The Carbon-Based Compositions

In general, the carbon-based compositions of the invention contain a pillared carbon material doped with a metal, preferably selected from alkali metals, alkaline-earth metals, and combinations thereof. Without limitation, metals such as Li, Na, K, Be, Mg, Ca and combinations thereof, are preferred. Other metals or elements may also be present provided they do not significantly interfere with the hydrogen storage capacity of the carbon-based compositions.

The carbon material is generally suitable for forming metal intercalated carbon materials containing layers of carbon intercalated with alkali metal. Without limitation, such carbon materials include graphite, graphene, carbon nanostructures, and combinations thereof. Representative of such carbon nanostructures are carbon nanofibers, carbon nanocells, carbon nanobarrels, multi-wall carbon nanotubes, single-wall carbon nanotubes and combinations thereof. Such carbon nanostructures, and methods of making them, are generally known and are well-described in the literature and in numerous patents (see, e.g., U.S. Pat. No. 6,159,538 to Rodriguez et al.). The invention is not strictly limited to these carbon structures, however, and other carbon materials or forms of carbon structures may be suitable for use as well. While it is preferred that the carbon material be essentially carbon, minor amounts of an impurity or additive may be present, including, e.g., boron, nitrogen and combinations thereof.

The atomic proportion of the doped metal to the carbon atoms in the pillared carbon material is preferably in the range of about 1:3 to about 1:24, more preferably in the range of about 1:3 to about 1:8, and most preferably in the range of about 1:3 to about 1:6. Where more than one metal is present, the atomic proportions of each metal may be the same or different, and may be modified, if desired, depending upon the amount of each of the particular metals present.

As noted, the pillared carbon material is preferably a layered intercalated carbon material. While the invention is not limited to a specific interlayer distance, it is generally intended that the interlayer distance between such layers of carbon, or intertube distance between nanotubes, will be suitable to allow for a reversible hydrogen storage capacity that is suitable for the intended application. For example, where the carbon-based composition is used for transportation-related applications, such as in an automobile hydrogen storage device, the interlayer or intertube distance is preferably in the range of about 6 Å to about 12 Å.

In an alternate aspect of the invention, it is preferred that the carbon-based composition provides a molecular hydrogen storage capacity of at least about 3 wt. % at 25° C. and a pressure of about 10 bar, more preferably a molecular hydrogen storage capacity of at least about 6.5 wt. % at 25° C. and a pressure of about 10 bar.

### Method of Making the Compositions

The method of making the carbon-based hydrogen storage composition is generally not limited to a particular procedure or series of steps. Instead, a number of techniques or steps may be utilized to form carbon-based compositions according to the present invention.

In one embodiment, the method may comprise providing a solvated alkali metal containing organic ligands; combining a carbon material with the solvated alkali metal containing organic ligands to form a carbon material co-intercalated with alkali metal cations containing organic ligands; carrying out a reaction between the organic ligand and the carbon material to form a pillared carbon material; and doping the pillared carbon material with a metal. The metal is preferably selected from alkali metals, alkaline-earth metals, and combinations thereof.

The solvated alkali metal containing organic ligands may be formed by solvating an alkali metal in an appropriate solvent. Preferred alkali metals include Li, Na, K, and combinations thereof. While in principle the solvent may be any solvent capable of solvating an alkali metal, it is preferred that the organic solvent is selected from heterocyclic solvents, particularly from cyclic ether compounds, such as 2,5-dihydrofuran, and the like. The invention is not limited to the selection of any particular solvent, however. Instead, the above solvents are mentioned for illustrative purposes only and should not be viewed as being comprehensive, nor should the choice of solvent be viewed as limiting the invention in any way. Those skilled in the art will recognize that any number of solvents or solvent mixtures may be used.

Co-intercalation of the solvated alkali metal containing organic ligands in the carbon material may be accomplished by techniques known in the art (see, generally, Abe et al., Synthetic Metals, 125, 249 (2002); and Inagaki et al., Carbon 39, 1083 (2001)).

The reaction between the organic ligand and the carbon material may be any suitable reaction useful to form a pillared carbon material. For example, a Diels-Alder type reaction may be carried out between unsaturated groups present in the organic ligands with host carbons present in a layered or nanostructured carbon material, such as layers of a graphitic material. It should be appreciated that other reactions may also be utilized to form intercalated carbon materials having interlayer or intertube distances that allow for the reversible storage of molecular hydrogen. For example, non-valence or ionic reactions may be used to bind the organic ligand and/or the alkali metal to the carbon material to form a pillared structure in which the interlayer or intertube distance is expanded.

Additional doped metal is also incorporated into the pillared carbon material, preferably as an intercalated metal selected from alkali metals, alkaline-earth metals, and combinations thereof. As noted above, the doped metal may be, e.g., Li, Na, K, Be, Mg, Ca and combinations thereof and the carbon material may be, e.g., graphite, graphene, carbon nanostructures, and combinations thereof. Without limitation, the carbon material is preferably graphite, graphene, carbon nanofibers, carbon nanocells, carbon nanobarrels, multi-wall carbon nanotubes, single-wall carbon nanotubes and combinations thereof.

Doping of the metal may be performed by any suitable technique, such as by mechanical (e.g. ball) milling, e.g., as mentioned in U.S. Pat. No. 6,596,055 to Cooper et al. Other techniques may also be utilized, however, including solid-state reactions between carbon materials and metal containing compounds, such as alkali metal salts (e.g., as mentioned in U.S. Pat. No. 6,471,936 to Chen et al.). Such techniques are generally known to the skilled artisan and need not be described in detail herein (see, e.g., T. Enoki et al., Graphite Intercalation Compounds and Applications, Oxford Univ. Press, 2003; S. Orimo et al. J. Applied Physics, 90(3), 1545 (2001)). Although not limited to the use of ball milling alone, such mechanical techniques are preferred.

It is generally preferred that such doping includes mechanical milling of the pillared carbon material to intercalate the metal. As noted above, the method of the invention provides an atomic proportion of the metal to the carbon atoms in the pillared carbon material that is preferably in the range of about 1:3 to about 1:24, more preferably in the range of about 1:3 to about 1:8, and most preferably in the range of about 1:3 to about 1:6.

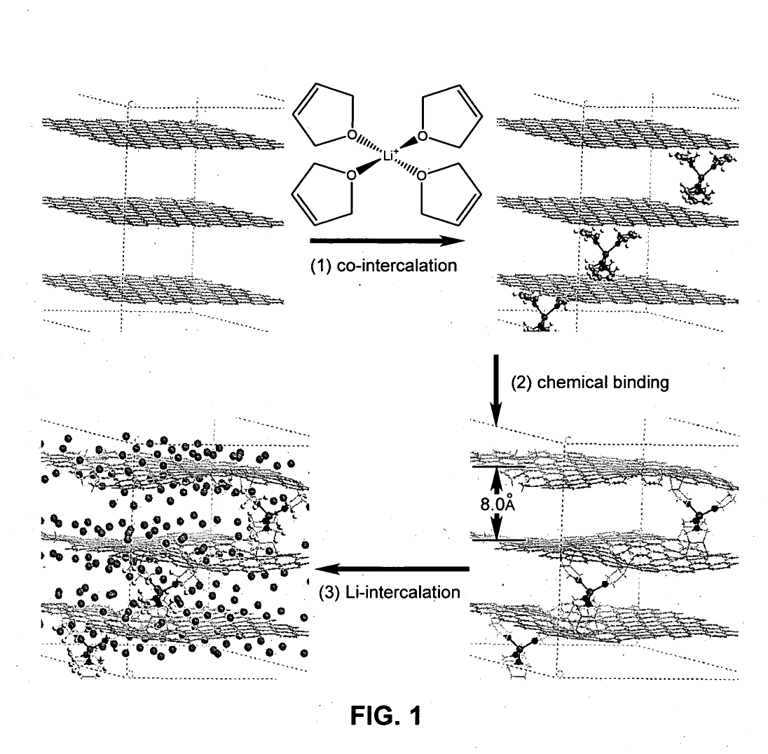

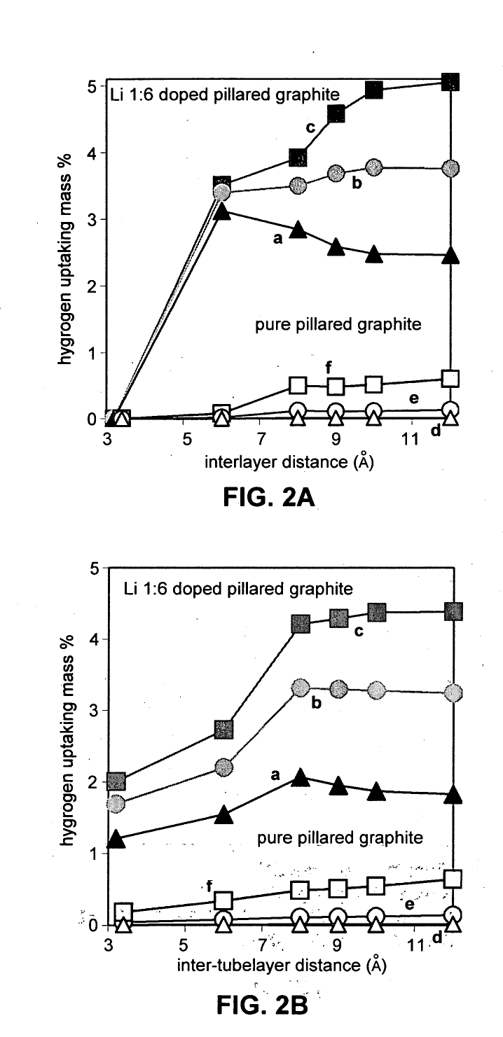

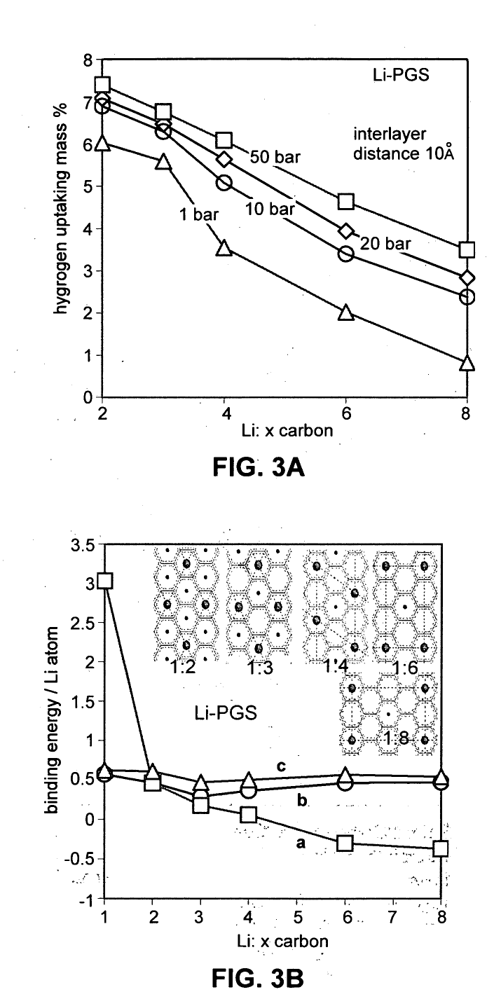

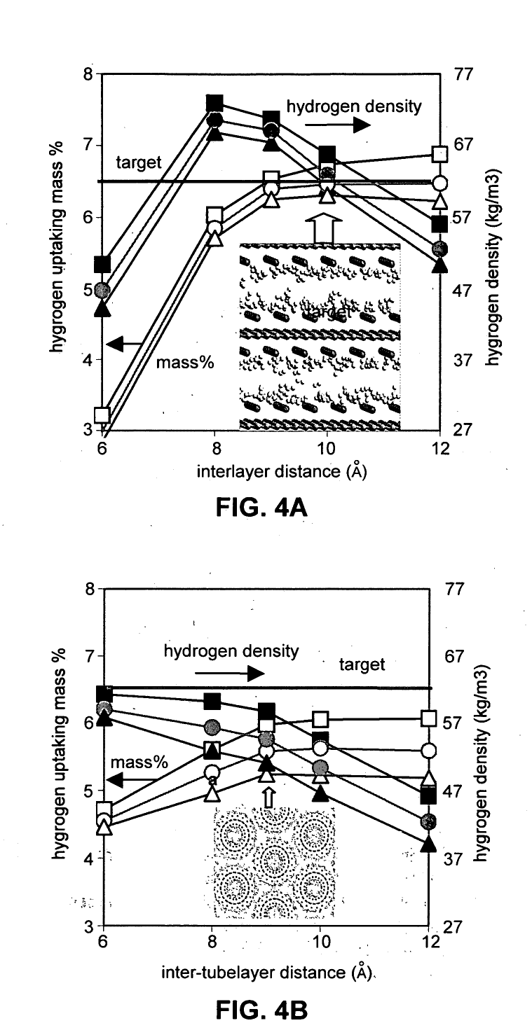

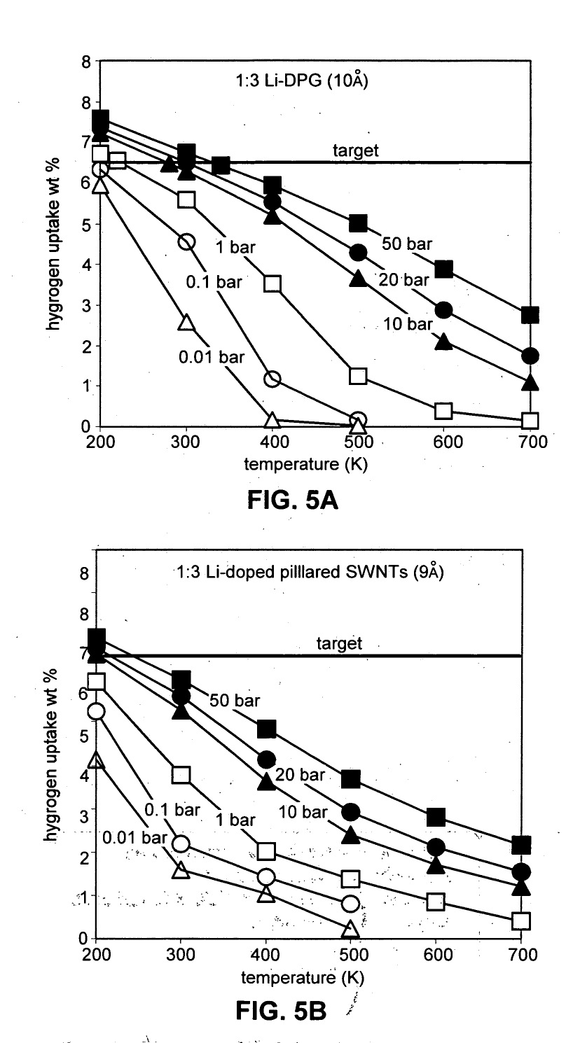

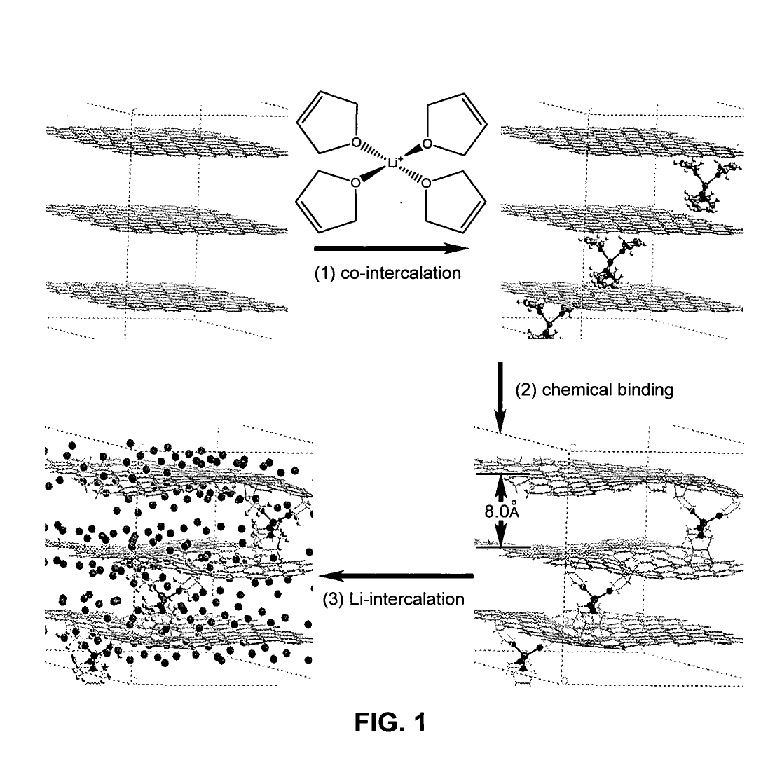

For the purposes of illustration; one possible scheme to synthesize a practical hydrogen storage carbon-based composition is schematically illustrated in FIG. 1. As shown in this figure, (1) ternary compounds are first produced by the reaction between host carbons and solvated alkali cations, e.g. 2,5-dihydrofuran solvated Li cations, in low concentration such that the interlayer spaces of graphite are expanded. A Diels-Alder type reaction (2) between the ligands of the organic solvent and the graphite sheets is then carried out to build covalent bonds that would maintain the interlayer space of the graphite under operating conditions. Li intercalation (3) and mechanical milling such as ball milling are used to synthesize doped pillared graphite (DPG) of higher Li concentration.

### Applications and Uses

The present invention also relates to various applications and uses in which hydrogen is stored in the carbon-based compositions. For example, the compositions of the invention may be utilized in a hydrogen storage system to store hydrogen and later reversibly obtain hydrogen from the system by reducing the pressure and/or increasing the temperature. Such applications include those associated with transportation, e.g. hydrogen storage systems developed for use in automobiles, trains, boats, and the like. Devices such as fuel cells, which may be used as battery replacements in, e.g., laptops and other computers, cell phones, hair dryers, etc., are also suitable applications for the carbon-based hydrogen storage compositions. Other applications, such as the storage of hydrogen from home, plant or offshore production of hydrogen from the conversion of hydrocarbons, are also possible. The compositions may also be used to preferentially absorb hydrogen, or another gas, from a mixture of gases.

It should be appreciated that the invention is not limited to any specific application, technique, or device structure, and the carbon-based composition may be used in any system where hydrogen storage, or the generation of energy from hydrogen, is desired.

In addition, although the invention has been described as being suitable for hydrogen storage applications, other small gas molecules may also be stored in the carbon-based compositions, or in a hydrogen storage system comprising the carbon-based compositions, including, for example, O₂, CO₂, CH₄, He, NH₃, N₂O, CO and NO, and the like.

### Performance Simulations

The following performance information is included herein to provide a further understanding of the inventive carbon-based compositions and the improved hydrogen storage characteristics provided thereby over other carbon materials. It is to be understood that this information is provided herein for the purposes of illustration only and is not to be interpreted as limiting the claimed invention in any way.

To simulate the performance of the carbon-based compositions for H₂ storage, a multiscale computational strategy^{12,13} was developed in which quantum mechanics (QM) at the X3LYP level of Density Functional Theory (DFT) is utilized to accurately treat van der Waals interactions and to determine an accurate force field (FF).¹⁴ This force field with grand canonical MD (GCMD) calculations was used to determine the H₂ uptake as a function of pressure and temperature.¹³

As discussed below, normal condensed graphite and nanotube systems have been determined to be too dense to bind sufficient amounts of H₂. Graphene sheet (GS) and single wall nanotube (SWNT) systems which are pillared were considered to provide more space for sufficient hydrogen uptake. To determine the optimum performance, the space taken by the pillars was initially ignored; later, this space was taken into consideration.

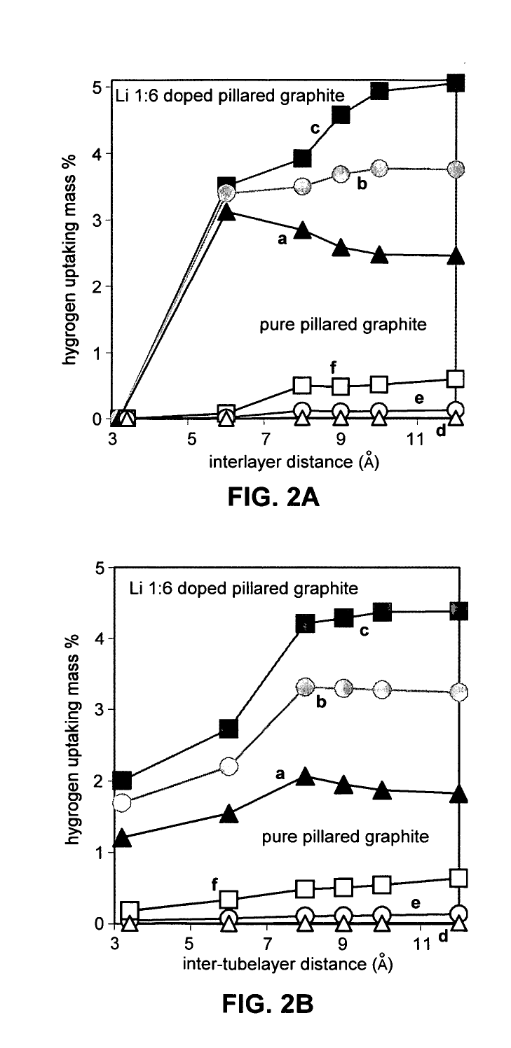

For the model SWNT, a (10,10) bundle was considered, which leads to a tube diameter of ˜13.6 Å, close to the mean diameter most frequently observed in SWNT synthesized by the arc-discharge or pulsed-laser vaporization techniques¹⁵. Curves (a) (b) and (c) in FIG. 2B show the predicted H₂ storage at 300 K and various pressures for pure pillared SWNTs (P-SWNT) as a function of the Interlayer Distance (ILD) between the SWNT.

The first point at 3.4 Å in FIG. 2B corresponds to the equilibrium ILD in the SWNT crystal, where 0.2 mass % at 50 bar was found, due entirely to the internal spaces of the SWNTs. These results are in good agreement with recent experiments^{2,3,6} and computations on SWNTs¹⁶. For example, Ye et al.^{3,6} reported 2-4 mass % storage for 20-50 bar at 80 K, comparable to the calculated results of 3-4 mass % at the same conditions reported here; Hirshel² reported 0.005 mass % storage at 300 K and 1 bar while 0.01 mass % was calculated under these conditions. For pillared SWNT (P-SWNT), a slight increase to 0.1 mass % at 10 bar and 0.5 mass % at 50 bar for ILD >8 Å was observed.

The performance of pure pillared graphene sheets (PGS) is similar. Curves (a) (b) and (c) in FIG. 2A show the predicted hydrogen storage for as a function of ILD. The first point (3.4 Å) corresponds to the equilibrium ILD in bulk graphite, leading to zero hydrogen uptake. As the ILD is increased to over 8 Å, the hydrogen uptake for PGS reaches 0.1 mass % at 10 bar and 0.5 mass % at 50 bar. These results suggest that the hydrogen storage capacity at ambient conditions is very limited for carbon-only systems such as graphene sheets and SWNTs, even if pillared to provide more space for the hydrogen.

In order to increase the hydrogen storage capacity, Li was added to the PGS and P-SWNT systems. Without intending to be bound by theory, it is believed that the high electron affinity of the sp² carbon framework would separate the charge from the Li, providing strong stabilization of the molecular H₂. An Li-doping concentration of Li:C=1:6 was first considered, which corresponds to the most stable conformation of Li-GIC (graphite intercalated compound) at ambient conditions. Curves (d) (e) and (f) in FIG. 1a show the results for Li-PGS. The first point at ILD=3.4 Å shows that Li-GIC does not exhibit hydrogen storage capacity, in agreement with the experimental observation of Pinkerton et al.¹¹. Curves (d) (e) and (f) in FIG. 2B show the results for Li-P-SWNT. The equilibrium ILD of 3.4 Å leads to ˜1.2 mass % hydrogen storage at 1 bar, which increases to ˜2.0 mass % for 50 bar. Here 99.5% of the storage comes from the space inside the nanotubes. These results suggest an explanation for the differences observed between different experiments¹⁰. Pinkerton et al.¹¹ found no observable hydrogen storage capacity for Li-doped nanotubes, but they used closed-end nanotubes that would prevent H₂ from entering the tubes. Yang¹⁰ made nanotubes by chemical vapor deposition followed by purification with strong acid, which will cut off the nanotube caps¹⁰, allowing the H₂ to go inside. Yang found ˜2.5 mass % hydrogen storage for Li-doped nanotubes at 1 bar and ambient temperature. This is consistent with the present results of 1.2 mass % at the same conditions. The small difference here might be because an infinite crystal with no surfaces was considered, whereas the materials of Yang's experiments likely had substantial surface area that might increase the net storage. It was determined that Li-doped carbon SWNT exhibits modest hydrogen storage capacity at ambient conditions, but not enough to meet the DOE requirements for transportation.

In order to increase the hydrogen storage capacity, our studies have suggested that additional doping and modified carbon materials were believed to be necessary. As further discussed below, increasing hydrogen storage in carbon materials with additional Li-doping and modified nanostructures was therefore evaluated.

The results provided in FIG. 2 show that Li-doped Pillared Graphene Sheets (Li-PGS) and Li doped Pillared SWNT (Li-P-SWNT) in which graphene or SWNT sheets are separated by an ILD of 6 to 12 Å significantly enhance the hydrogen storage capacity. This is in sharp contrast to the situation for undoped PGS or P-SWNTs where increasing the ILD has a very limited effect on the hydrogen storage capacity. This also differs from an unpillared system where Li-doping has only a very modest effect on hydrogen storage.

The Li-doped pillared systems also lead to a much larger benefit from increased pressure. Thus, FIG. 2 shows that at 10 bar and room temperature the hydrogen storage capacity increases from 0.1 mass % for pure pillared graphene to 3.7 mass % for Li-PG (Li:C=1:6) with the ILD increased to 10 Å.

These results also show that Li dopants act as positive (acidic) cores that attract hydrogen molecules. The lack of hydrogen storage capacity in ordinary graphite and SWNT systems is believed to be due to the restricted space available around the Li dopants. These results suggest that by pillaring to increase the interlayer distances and by increasing the Li-doping concentration, the DOE hydrogen storage goals are attainable with Li-doped pillared carbon materials.

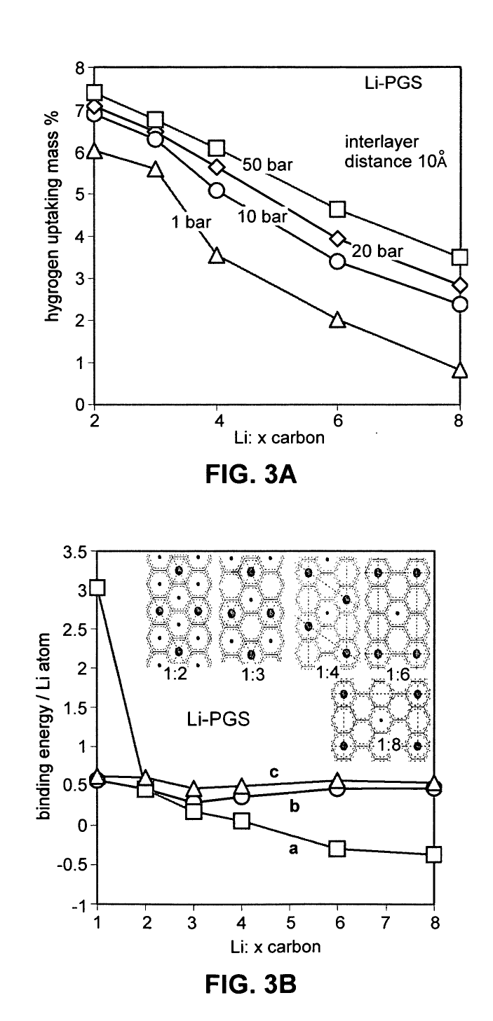

Given the very favorable synergistic effect of combining Li-doping with pillaring of graphitic sheets, optimization of the amount of Li was then considered. FIG. 3A shows that by increasing the Li-doping concentration the hydrogen storage capacity increases nearly linearly, increasing from 3.7 mass % at Li:C=1:6 to 6.5 mass % at Li:C=1:3 (for Li-PGS with ILD=10 Å at 10 bar).

To determine the maximum feasible concentration, DFT calculations were conducted on Li-GIC and Li-PGS for various Li:C ratios¹⁸. FIG. 3B shows that at the equilibrium interlayer distance Li-GIC is most stable for Li:C=1:6, and Li:C=1:8, in agreement with experimental observation. However, for Li-PGS, a ratio of Li:C=1:3 is the most stable structure for ILD >8 Å.

Li-GIC with 1:2 and 1:3 doping concentration have been synthesized experimentally¹⁹, but the Li:C=1:2 structure was meta-stable, decomposing to a Li:C=1:3 structure plus Li metal as the pressure was reduced. Using bundles of SWNT, it has-been possible to get up to Li:C=1:3.75; with ball milling²⁰ this ratio has been increased up to Li:C=1:2.2.

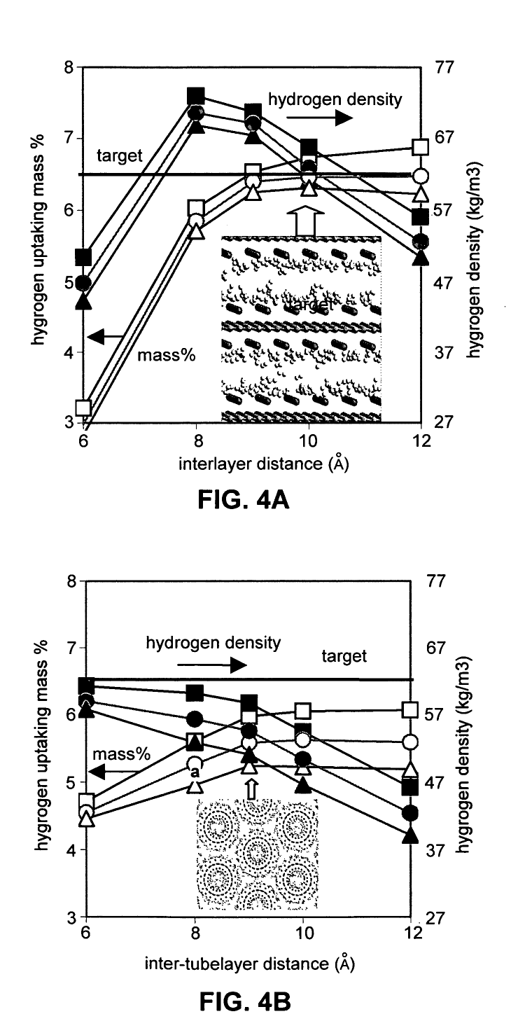

FIG. 4A shows the hydrogen storage performance for the optimum Li-PGS (Li:C=1:3 and ILD=10 Å). At room temperature and 20 bar this leads to hydrogen storage of 6.5 mass % and 62.9 kg/m³, which fulfills the DOE transportation requirements (6.5 mass % and 62 kg/m³). These results further suggest that the DOE target could be surpassed to 6.7 mass % and 65.8 kg/m³ with an operating pressure of 50 bar.

FIG. 4B shows the results for Li-P-SWNT for Li:C=1:3 and ILD=9 Å. Here, hydrogen storage of 6.0 mass % and 61.7 kg/m³ at room temperature and 50 bar was obtained.

Based on these results, it appears that Li-PGS has better hydrogen storage performance than Li-P-SWNT. Since LI-PGS is also likely to be much less expensive than Li-P-SWNT, it should be an excellent candidate for developing a practical H₂ storage system for transportation.

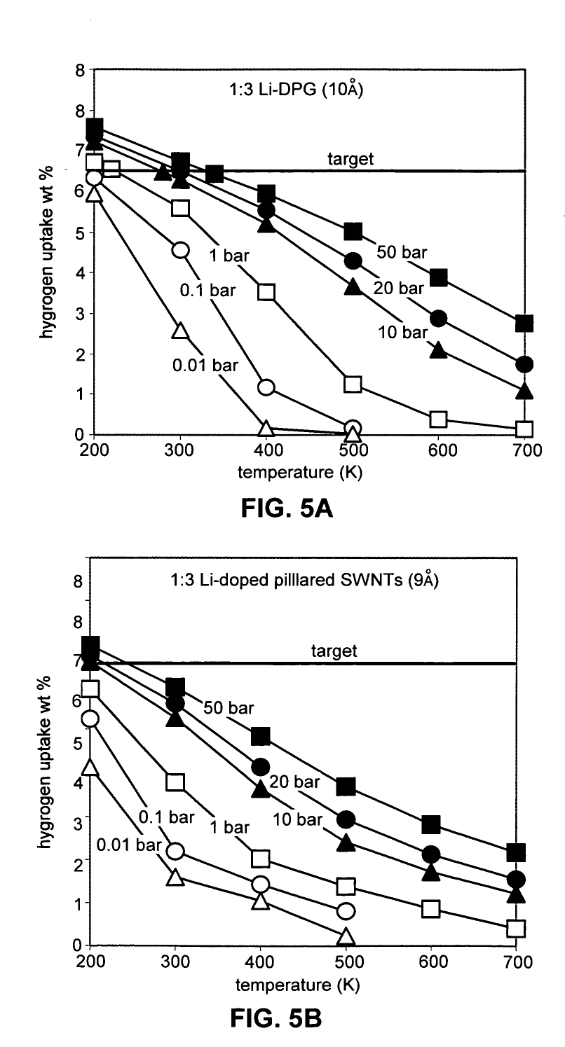

FIGS. 5A and 5B illustrate how temperature and pressure effects can be used to design the load/unload operating process for a reversible hydrogen storage system. For example, as shown in FIG. 5A, Li-PGS (Li:C=1:3 with ILD=10 Å) reaches 6.5 mass % hydrogen uptake under loading conditions of 20 bar and 300 K. Under the unloading conditions of 0.01 bar and 400 K, the residual hydrogen is 0.2 mass %. Therefore, the total load/unload will provide 6.3 mass % reversible hydrogen, an amount far superior to other present hydrogen storage systems.

In computer simulations of pillared SWNT systems subjected to ball milling to increase the doping concentration, for Li:C=1:3, and one pillar per 116 carbons, an ILD=8.0 Å was obtained. These results are consistent with reports indicating that the interlayer distance of GIC can be expanded from around 3.4 Å to 8.7-12.4 Å²¹. Carrying out GCMC calculations on this system resulted in a determination that 5.7 mass % hydrogen may be stored at 300 K and 50 bar. For maximum performance, the pillar structure is preferably modified to yield an ILD of about 10 Å.

In making these determinations of hydrogen storage capacity, only a purely passive system has been considered. However, these studies show that Li-PGS and Li-P-SWNT systems are quite compressible so that an active process in which the system is under tension while loading with H₂ and under compression to extract the H₂ as it is needed may provide much higher reversible storage and better control over loading and extraction.

It is to be understood that while the invention has been described in conjunction with the preferred specific embodiments thereof, that the foregoing description is intended to illustrate and not limit the scope of the invention. Other aspects, advantages and modifications within the scope of the invention will be apparent to those skilled in the art to which the invention pertains.

All patents, patent applications, and publications mentioned herein are hereby incorporated by reference in their entireties.

### REFERENCES AND NOTES

1. L. Schlapbach, A. Zuttel, Nature 414, 353 (2001) and references cited therein.
2. M. Hirscher et al., Appl. Phys. A 72, 129 (2001).
3. Y. Ye et al., Appl. Phys. Lett. 74, 2307 (1999).
4. A. C. Dillon et al., Nature 386, 377 (1997); A. C. Dillon et al., Proceeding of the 2000 Hydrogen Program Review, NREL/CP-507-28890.
5. C. Liu et al., Science 286, 1127 (1999); H. M. Cheng, C. Liu et al., Z. Metalkd. 91, 306 (2000).
6. C. C. Ahn Y. Ye, et al., Appl. Phys. Lett. 73, 3378 (1998); Y. Y. Fan et al., Carbon 37, 1649 (1999).
7. D. J. Browning, et al., Nano Lett. 2, 201, 2002.
8. S. Orimo, et al., Appl. Phys. Lett. 75, 3093 (1999).
9. P. Chen, et al., Science 285, 91 (1999).
10. R. T. Yang, Carbon 38, 623 (2000).
11. F. E. Pinkerton, et al., J. Phys. Chem. B 104, 9460 (2000).
12. To describe the van der Waals interactions between the Li dopants, carbon materials, and hydrogen systems we use Morse potentials with the parameters determined by fitting to accurate ab initio calculations as described here. (i) For the H-H vdW term, we fitted the potential curve between two H₂ molecules using CCSD(T) ab initio QM with the aug-cc-pVQZ basis set. (ii) For the C-H vdW term, we calculated the interaction between H₂ and C₂ molecules using the MP4 ab initio QM with the aug-cc-pVTZ basis set plus mid-point bond functions. (iii) To determine the interactions between doped Li ions and hydrogen molecules, we considered a planar C₃₂ cluster (10 aromatic rings) doped with one Li atom on each side (in the optimum configuration found for Li:C=1:3 Li-PGS) to which one H₂ was bonded. These calculations used X3LYP [6-311G(d,p) basis], a new DFT functional which leads to an accurate description of van der Waals and hydrogen bond interactions¹⁷. High quality ab initio calculations (MP4/6-311G(d,p)//MP2/6-311G(d,p)) have previously been reported²⁰ showing that Li cation binds six H₂ molecules at zero Kevin with the enthalpy for adding successive H₂ of −5.39, −4.3, −4.07, −3.65, −1.87 and −2.3 kcal/mol; this agrees well with the X3LYP results of −5.12, −4.47, −3.9, −3.63, −1.55 and −1.52 kcal/mol for the same system.
13. The GCMC calculations were carried out using the sorption module of Cerius2 (Accelrys, San Diego) with the FF described in ref. 15. In order to obtain an accurate measure of H₂ loading, we used 1,000,000 configurations to compute the average loading for each condition (pressure and temperature). To minimize undesirable boundary effects we used a finite three-dimensionally periodic cell containing four independent sheets each with 216 carbon atoms.
14. X. Xu and W. A. Goddard III “The X3LYP Extended Density Functional for Accurate Descriptions of Nonbond Interactions (London Forces, Electrostatics, and Hydrogen Bonding), Spin States, and Thermochemical Properties,” submitted for publication.
15. M. S. Dresselhaus et al., Science of Fullerenes and Carbon Nanotubes, (Academic Press, New York, 1996).
16. Q. Wang and J. K. Johnson, J. Chem. Phys. 110, 577, 1999.
17. M. Barbatti et al., J. Chem. Phys. 114, 2213 (2001).
18. For these calculations we employed the CASTEP periodic QM software (from Accelrys) using the Perdew GGA II density functional combined with a plane-wave basis set. The geometries of Li-GIC or Li-PGS at various doping concentrations were fully optimized. We used a kinetic energy cutoff of 380 eV for the plane wave basis set. We used the default convergence criteria which correspond to 0.0002 eV for the energy change per atom, 0.001 Å for the rms atomic displacement and 0.05 eV/Å for the rms residual force.
19. H. Shimoda et al., Phys. Rev. Lett. 88, 0155021 (2002); J. Zhao et al., Phys. Rev. Lett. 85, 1706 (2000).
20. R. Janot, et al., Carbon 39, 1931 (2001).
21. T. Abe, et al., Syn. Metals 125, 249 (2002); M. Inagaki et al., Carbon 39,1083 (2001).

1. A carbon-based hydrogen storage composition comprising a pillared carbon material doped with a metal.

2. The composition of claim 1, wherein the metal is selected from alkali metals, alkaline-earth metals, and combinations thereof.

3. The composition of claim 2, wherein the metal is selected from Li, Na, K, Be, Mg, Ca and combinations thereof.

4. The composition of claim 1, wherein the carbon material is selected from graphite, graphene, carbon nanostructures, and combinations thereof.

5. The composition of claim 4, wherein the carbon material is selected from graphite, graphene, carbon nanofibers, carbon nanocells, carbon nanobarrels, multi-wall carbon nanotubes, single-wall carbon nanotubes and combinations thereof.

6. The composition of claim 1, further comprising an impurity or an additive.

7. The composition of claim 6, wherein the impurity or additive is selected from B, N and combinations thereof.

8. The composition of claim 1, wherein the atomic proportion of the metal to the carbon atoms in the pillared carbon material is in the range of about 1:3 to about 1:24.

9. The composition of claim 8, wherein the atomic proportion of the metal to the carbon atoms in the pillared carbon material is in the range of about 1:3 to about 1:8.

10. The composition of claim 9, wherein the atomic proportion of the metal to the carbon atoms in the pillared carbon material is in the range of about 1:3 to about 1:6.

11. The composition of claim 1, wherein the pillared carbon material has an interlayer or intertube distance in the range of about 6 Å to about 12 Å.

12. The composition of claim 10, wherein the pillared carbon material has an interlayer or intertube distance in the range of about 6 Å to about 12 Å.

13. The composition of claim 12, having a molecular hydrogen storage capacity of at least about 3 wt. % at 25° C. and a pressure of about 10 bar.

14. The composition of claim 13, having a molecular hydrogen storage capacity of at least about 6.5 wt. % at 25° C. and a pressure of about 10 bar.

15. A hydrogen storage system comprising a carbon-based composition according to claim 1.

16. In a hydrogen storage system, wherein a carbon material is used to store hydrogen, the improvement which comprises employing a carbon-based composition comprising a pillared carbon material doped with a metal.

17. A method of making a carbon-based hydrogen storage composition, comprising
providing a solvated alkali metal containing organic ligands;
combining a carbon material with the solvated alkali metal containing organic ligands to form a carbon material co-intercalated with alkali metal cations containing organic ligands;
carrying out a reaction between the organic ligands and the carbon material to form a pillared carbon material; and
doping the pillared carbon material with a metal.

18. The method of claim 17, wherein the alkali metal of the solvated alkali metal cation is selected from Li, Na, K, and combinations thereof.

19. The method of claim 17, wherein the doped metal is selected from alkali metals, alkaline-earth metals, and combinations thereof.

20. The method of claim 19, wherein the doped metal is selected from Li, Na, K, Be, Mg, Ca and combinations thereof.

21. The method of claim 17, wherein the carbon material is selected from graphite, graphene, carbon nanostructures, and combinations thereof.

22. The method of claim 21, wherein the carbon material is selected from graphite, graphene, carbon nanofibers, carbon nanocells, carbon nanobarrels, multi-wall carbon nanotubes, single-wall carbon nanotubes and combinations thereof.

23. The method of claim 17, wherein said organic ligand solvated alkali metal cation comprises an organic solvent selected from heterocyclic solvents.

24. The method according to claim 23, wherein said organic solvent is a cyclic ether compound.

25. The method according to claim 24, wherein said organic solvent is 2,5-dihydrofuran.

26. The method according to claim 17, wherein said doping includes intercalation of the metal and ball milling of the pillared carbon material.

27. The method of claim 17, wherein the carbon material further comprises an impurity or an additive.

28. The method of claim 27, wherein the impurity or additive is selected from B, N and combinations thereof.

29. The method of claim 17, wherein the atomic proportion of the metal to the carbon atoms in the pillared carbon material is in the range of about 1:3 to about 1:24.

30. The method of claim 29, wherein the atomic proportion of the metal to the carbon atoms in the pillared carbon material is in the range of about 1:3 to about 1:8.

31. The method of claim 30, wherein the atomic proportion of the metal to the carbon atoms in the pillared carbon material is in the range of about 1:3 to about 1:6.

32. The method of claim 17, wherein the pillared carbon material has an interlayer or intertube distance in the range of about 6 Å to about 12 Å.

33. The method of claim 31, wherein the pillared carbon material has an interlayer or intertube distance in the range of about 6 Å to about 12 Å.

34. The method of claim 33, wherein the carbon-based composition has a molecular hydrogen storage capacity of at least about 3 wt. % at 25° C. and a pressure of about 10 bar.

35. The method of claim 34, wherein the carbon-based composition has a molecular hydrogen storage capacity of at least about 6.5 wt. % at 25° C. and a pressure of about 10 bar.

36. In a method of making a hydrogen storage device, wherein a carbon material is used to store hydrogen, the improvement which comprises employing a carbon-based composition comprising a pillared carbon material doped with a metal.
